(19) United States
(12) Patent Application Publication
(10) Pub. No.: US 2003/0119456 A1
(43) Pub. Date: Jun. 26, 2003

(54) Voltage controlled quadrature oscillator with phase tuning

(76) Inventor: James Maligeorgos, Austin, TX (US)

Correspondence Address: Michael P. Adams, Winstead Sechrest & Minick P.C., 5400 Renaissance Tower, 1201 Elm Street, Dallas, TX, 75270-2199, US

(21) Appl. No.: 09/776,392

(22) Filed: Feb. 2, 2001

Related U.S. Application Data
(60) Provisional application No. 60/180,166, filed on Feb. 4, 2000.

(51) Int. Cl. H04B 1/40

(52) U.S. Cl. 455/87; 455/86

(57) ABSTRACT

A differential two-or-more stage oscillator with precision phase tuning is presented. The phase difference between the stages can be varied by differentially adjusting the propagation delays of each stage. In addition, an injection-locked differential two-or-more stage oscillator with precision phase tuning is presented. The phase relationship between the stages can be altered without altering the frequency of the oscillator by differentially altering input bias voltages coupled to each stage. Additionally, a mechanism for the realization of a self-calibrating image-reject mixer architecture within a radio transceiver utilizing the new oscillator circuits is introduced. The mechanism provides a practical means for allowing a portable wireless device, for example, a cellular telephone, to calibrate its internal receive and transmit image-reject-mixer's phase and amplitude errors without the use of an externally applied test signal.

### DESCRIPTION OF THE FIGURES

FIG. 1 is a block diagram of a differential 2 stage ring oscillator with variable quadrature output phases according to the present invention.

FIG. 2 is a schematic of the circuit of FIG. 1.

FIG. 3 is a schematic of a differential regenerative frequency divider according to the present invention.

FIG. 4 is a block diagram of an image reject mixer.

FIG. 5 is a block diagram of an improved image reject mixer according to the present invention.

### DETAILED DESCRIPTION OF THE PREFERRED EMBODIMENTS

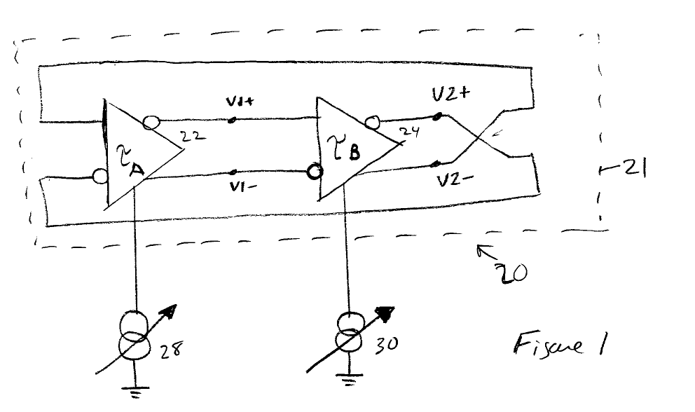

FIG. 1 shows a differential 2 stage ring oscillator 20 with quadrature output phases. Oscillator 20 includes a ring oscillator 21 and two current sources 28, 30. Ring oscillator 21 includes a pair of differential amplifiers 22 and 24 which are connected together as a ring oscillator. The propagation delay τ_{A} of amplifier 22 is controlled by varying the current of controllable current source 28 and the propagation delay τ_{B} of amplifier 24 is controlled by varying the current of controllable current source 30. The oscillation frequency of ring oscillator 21 is inversely related to the total propagation delay (τ_{A}+τ_{B}) of amplifiers 22 and 24. Signal V₁ is measured across nodes V₁₊ and V₁₋. Signal V₂ is measured across nodes V₂₊ and V₂₋. If the propagation delays, τ_{A} and τ_{B}, of amplifiers 22 and 24 are equal, then signal V₂ will lag 90° behind signal V₁ (i.e. signals V₁ and V₂ will be quadrature signals). Propagation delay τ_{A} of amplifier 22 can be changed by adjusting the current of current source 28. Similarly, propagation delay τ_{B} of amplifier 24 can be changed by adjusting the current of current source 30.

The frequency of ring oscillator 21 may be varied, without affecting the phase difference between signals V₁ and V₂, by adjusting the currents of current sources 28 and 30 proportionally.

The phase difference between signals V₁ and V₂ may be varied by differentially adjusting the propagation delays, τ_{A} and τ_{B}, of amplifiers 22 and 24. This is done by differentially adjusting the currents of current sources 28 and 30.

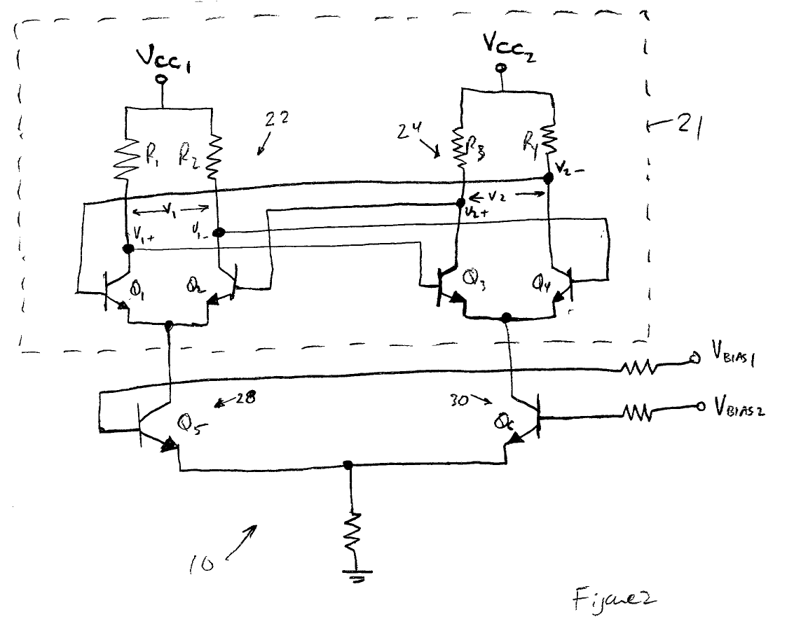

FIG. 2 is a schematic diagram of circuit 10. Amplifier 22 comprises a pair of emitter coupled amplifiers Q₁ and Q₂. Amplifier 24 comprises a pair of emitter coupled transistors Q₃ and Q₄. The collectors and bases of transistors Q₁- Q₄ are connected to form differential ring 21. The collectors of Q₁ and Q₂ are coupled to a voltage source V_{cc1} through resistors R₁ and R₂. The collectors of Q₃ and Q₄ are coupled to voltage source V_{cc2} through resistors R₃ and R₄.

Current source 28 comprises a transistor Q₅. The base of transistor Q₅ is coupled to at input voltage V_{bias1}, which controls the current of current source 28. Similarly, current source 30 comprises a transistor Q₆. The current of current source 30 is controlled by voltage signal V_{bias2}. Voltage signals V_{bias1} and V_{bias2} must have a

As the level of voltage signal V_{bias1} is increased, the current of current source 28 will increase. This will increase the switching speed and decrease the propagation delay of differential amplifier 22. Similarly, the switching speed and propagation delay of differential amplifier 24 are controlled by varying the level of voltage signal V_{bias2}.

Although the propagation delays of amplifiers 22 and 24 are described here as being controlled by varying the bias currents of the amplifiers (i.e. the currents of current sources 28 and 30), the same results may be attained by creating any imbalance in the electrical symmetry between amplifiers 22 and 24. For example: a bias voltage or current may be altered at any node of ring oscillator 21. Alternatively, a controllable capacitor, inductor or resistor may be coupled to any node to differentially alter the internal impedances in amplifiers 22 and 24.

Ring oscillator 21 may also be implemented as a pair of quadrature coupled differential oscillators.

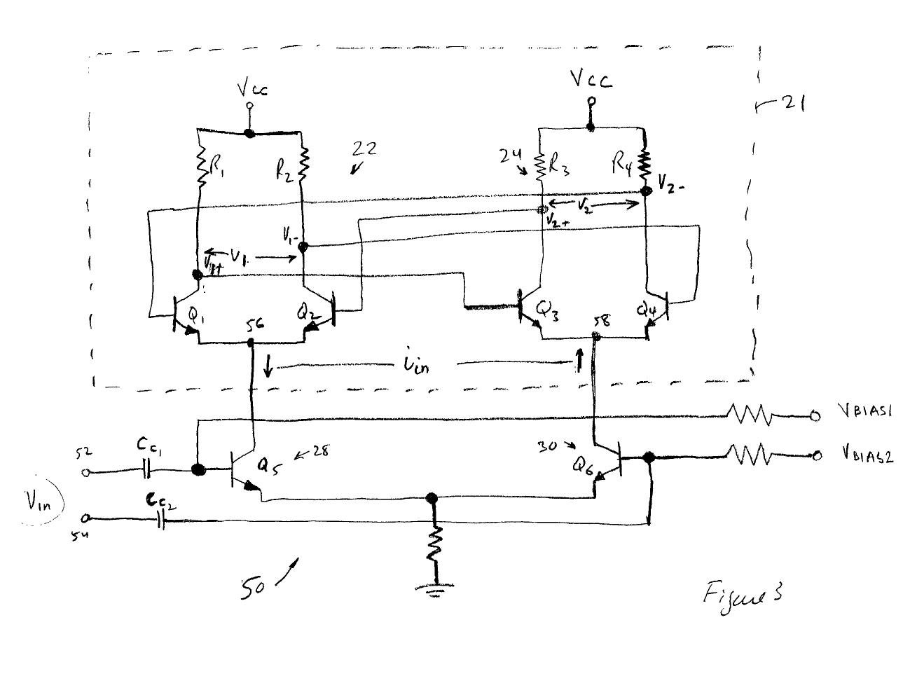

FIG. 3 shows a differential regenerative (i.e. dynamic) divider 50 with quadrature output. This circuit is identical to circuit 20, except that the bases of transistors Q₅ and Q₆ are additionally coupled to an input signal Vᵢₙ at nodes 52 and 54 through coupling capacitors C_{c1} and C_{c2}.

Signal Vᵢₙ is received at nodes 52, 54 and has a frequency fᵢₙ. Transistors Q₅ and Q₆ convert input signal Vᵢₙ into an alternating current signal iᵢₙ which is injected into emitter coupled nodes 56 and 58 of amplifiers 22 and 24. The frequency of current signal iᵢₙ is the same as the frequency fᵢₙ of input signal Vᵢₙ. This injection locks ring oscillator 21 such that the oscillation frequency f_{osc} of the ring oscillator is half the input frequency fᵢₙ of input signal Vᵢₙ.

If the propagation delays τ_{A} and τ_{B} of amplifiers 22 and 24 are configured to be the same, then signals V₁ and V₂ will be quadrature phased signals (i.e. they will be separated in phase by 90°).

The phase relationship between V₁ and V₂ can be altered, without altering the frequency of ring oscillator 21 by differentially altering input voltages V_{bias1} and V_{bias2}. Since ring oscillator 21 is injection locked to frequency fᵢₙ/2, it is only necessary to vary one of the input voltages V_{bias1} or V_{bias2}, with respect to the other, to vary the phase relationship between V₁ and V₂.

In radio system architectures, image reject mixing requires accurate quadrature local oscillator signal generators to attain high image rejection performance. This is required for both up (transmitter) and down (receiver) conversions. Known designs attempt to design the quadrature signal generator (frequency divider) to produce as accurately as possible a pair of signals (generally referred to as the inphase (I) and quadrature (Q) signals) which are separated by precisely 90°. It is impossible to account for all process tolerances which can impair the image rejection performance of an image reject architecture. Approximately 1° of phase error is common. This translates to a maximum image rejection of about 46 dB. Including other sources of phase and amplitude error in the quadrature down conversion path a typical specification for image rejection is approximately 35 dB. In order to improve image rejection beyond this level, a system is required for controlling the phase relation between the I and Q local oscillator signals with a high degree of precision. This system may be used to provide I and Q signals which have a phase relation which compensates for the other sources of phase error. In a particular case, the phase relation between the I and Q signals may be greater or less than 90°.

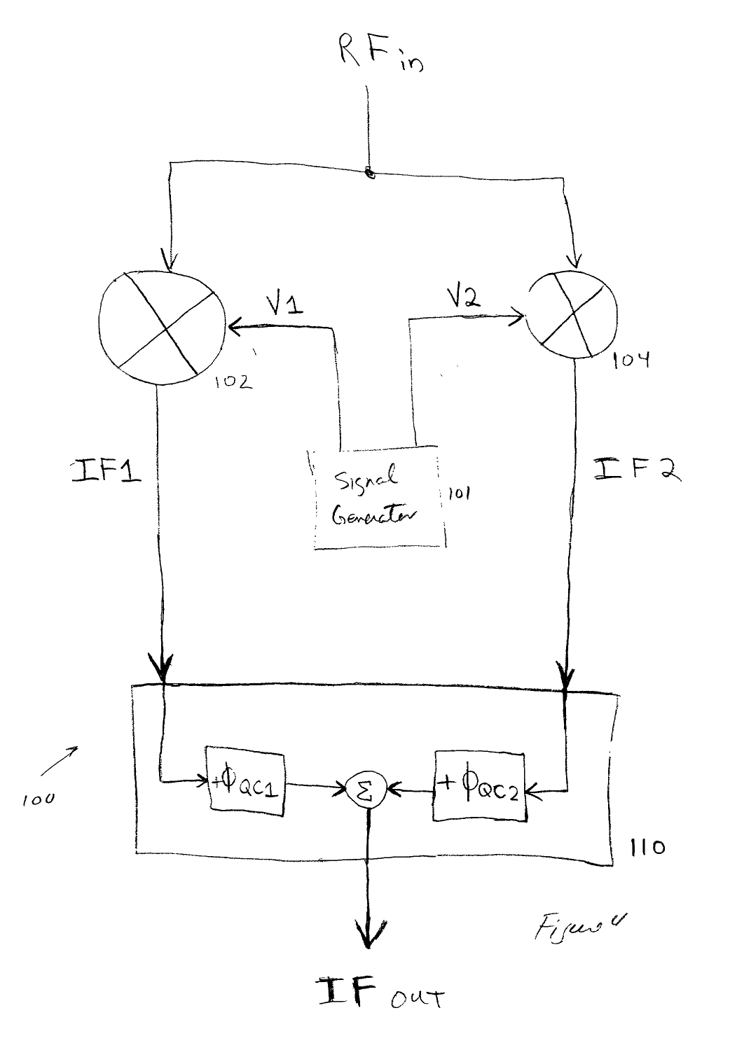

FIG. 4 is a block diagram of an image reject mixer 100 using the Hartley topology. Signal RFᵢₙ comprises a RF signal having a frequency f_{RF} and an image signal having a frequency f_{IM}. Signal generator 101 provides a pair of local oscillator signals V₁ (which takes the place of the I signal) and V₂ (which takes the place of the Q signal), both having the same frequency f_{LO}. Signals V₁ and V₂ have phase angles φ_{V1} and φ_{V2}. φ_{V1} is arbitrarily chosen as a reference for 0° phase. Signals V₁ and V₂ are mixed with the received signal RFᵢₙ in mixers 102 and 104 to provide a pair of signals IF₁ and IF₂. When high side injection is used (f_{LO} is greater than f_{RF}), the IF₁ signal comprises the RF signal converted to frequency (f_{LO}−f_{RF}) and the image signal (sideband) converted to frequency (f_{IM}−f_{LO}). Signal IF₂ comprises the RF signal converted to frequency (f_{LO}−f_{RF}) and shifted in phase by φ_{V2}° and the image signal converted to frequency (f_{IM}−f_{LO}) and shifted in phase by −φ_{V2}°.

The amplified signals IF₁ and IF₂ are combined by a quadrature combiner 110. Quadrature combiner 110 is designed to complete the image rejection by providing a phase shift φ_{QC1} to signal IF₁ and a phase shift φ_{QC2} to signal IF₂. Ideally, to maximize suppression of the image signal, φ_{QC1}−φ_{V1}=0° and φ_{QC2}+φ_{V2}=−180° (assuming high side injection). Ideally, φ_{V2}−φ_{V1}=90°, φ_{QC2}−φ_{QC1}=90°. In known quadrature combiners, φ_{QC2}−φ_{QC1} is generally not 90°. Typically a phase error exists, and the image is not maximally suppressed. In addition, known quadrature combiners also introduce amplitude errors in the IF₁ and/or IF₂ signal paths. For example, both signal IF₁ may be reduced in amplitude by N dB.

Current state of the art systems attempt to maintain the 90° phase separations between φ_{V1} and φᵥ₂ and between φ_{QC1} and φ_{QC2}. It has been found that image rejection performance can be substantially increased by adjusting the phase difference to compensate for the phase error in the quadrature combiner 110. In addition, amplitude errors in the IF₁ and IF₂ signal paths can be compensated for.

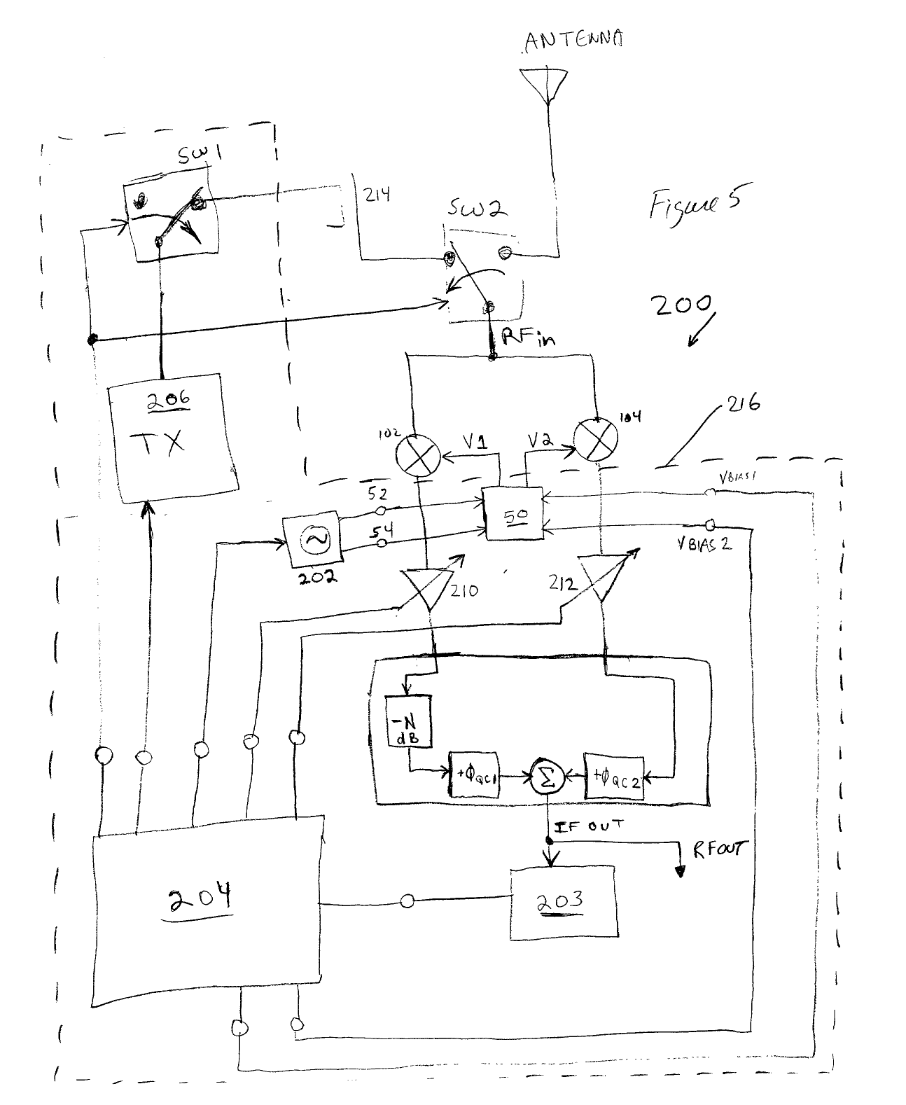

FIG. 5 shows an improved image reject mixer 200. Components of image reject mixer 200 which correspond to components of image reject 100 are identified by the same reference numerals. Signal generator 101 of image reject mixer has been replaced with circuit 50 (FIG. 3). Nodes 52 and 54 of circuit 50 are coupled to a signal generator 202.

Output signal IFₒᵤₜ is received by a carrier level detector 203. Carrier level detector provides a signal to feedback controller 204. Feedback controller provides control signals to switches SW₁ and SW₂, calibration signal transmitter 206, signal generator 202, amplifiers 210, 212 and provides voltage signal V_{bias1} and V_{bias2}. Image reject mixer has a calibration mode and operation mode.

Initially, in the calibration mode the following configuration is set by controller 204:

(a) switches SW₁ and SW₂ are configured to connect calibration signal transmitter 206 to input node RFᵢₙ;

(b) signal generator 202 is configured to produce a signal with a frequency twice that required for the local oscillator signals V₁ and V₂; and

(c) voltage signals V_{bias1} and V_{bias2} are configured to initiate the operation of circuit 50 with the phase delays of amplifiers 22 and 24 being approximately equal; and

(d) calibration signal transmitter 206 is configured to generate a signal at the frequency of the image;

(e) the gains of amplifiers 210 and 212 are set equal.

Controller 204 then runs a calibration algorithm. Signal IFₒᵤₜ is generated as in image reject mixer 100. Signal IFₒᵤₜ will contain the image signal generated by calibration signal generator 206. The level of signal IFₒᵤₜ will correspond to phase and amplitude errors introduced in quadrature combiner 110 and other components of image reject mixer 200. Carrier level detector provides a signal corresponding to the level of signal IFₒᵤₜ to controller 204.

Controller 204 then adjusts the relative propagation delays of amplifier 22 and 24 (within circuit 50) to control the relative phase difference between V1 and V2 to reduce the signal level of IFₒᵤₜ as much as possible. Controller 204 than adjusts the relative gains of amplifiers 210 and 212 to reduce the signal level of IFₒᵤₜ as much as possible. Controller 204 then alternately attempts to reduce the signal level of IFₒᵤₜ by adjusting the phase difference between V₁ and V₂ and by adjusting the relative gains of amplifiers 210 and 212. When no further reduction of IFₒᵤₜ is attained for several iterations, the calibration mode is terminated by configuring switches SW₁ and SW₂ to disconnect the calibration signal transmitter 206 from node RFᵢₙ and to connect the antenna to node RFᵢₙ.

Image reject mixer 200 then enters the operation mode. The setting for the phase difference between V₁ and V₂ and the relative gains of amplifiers 210 and 212 determined during the calibration mode are retained during the operation mode to maintain the improved image reject performance of image reject mixer 200 attained during calibration mode.

Image reject mixer 200 may be integrated. The functionality of the elements of image reject mixer 200 contained within dashed boundary 216 may wholly or partially implemented using analog or digital technology.

In addition, image reject mixer 200 may be used with a transmitter.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

### References

[1] N. J. Shah, A. S. Sawkar, J. A. Marinho, K. K. Sabnani, T. F. La-Porta, T-C Chiang, “Wireless data networking, standards and applications,” Bell Labs Technical Journal, vol. 5, no.1, January-March 2000, pp. 130-49.

[2] R. Schneiderman, “Making RF fit [wireless design]”, Portable-Design, vol.6, no.8, August 2000, pp. 22-8

[3] S. Srikanteswara, J. H. Reed, P. Athanas, R. Boyle,“A soft radio architecture for reconfigurable platforms,” IEEE Communications Magazine, vol. 38, no.2, February 2000.

[4] B. Razavi, “Design considerations for direct-conversion receivers,” IEEE Transactions on Circuits and Systems II, vol. 44, no. 6, June 1997.

[5] I. J. Bahl, P. Bhartia, Microwave Solid State Circuit Design, New York: Wiley and Sons Inc., 1998.

[6] J. R. Long, R. A. Hadaway and D. L. Harame, “A 5.1-5.8 GHz low-power image-reject downconverter in SiGe technology,” Proceedings of the IEEE Bipolar and BiCMOS Technology Meeting, Minneapolis Minn., September 1999, pp. 67-70.

[7] Federal Communications Commission (FCC), “Amendment of the commission's rules to provide for operation of unlicensed NII devices in the 5 GHz frequency range,” ET Docket No. 96-102, Jan. 9, 1997.

[8] European TSI RES10, “Co-operation with ETSI,” ETSI RES10 96/40, May 31, 1996.

[9] Federal Communications Commission (FCC), “Amendment of parts 2 and 90 of the commission's rules to allocate the 5.850-5.925 GHz band to the mobile service for dedicated short range communications of intelligent transportation services,” ET Docket No. 98-95 RM-9096, October 1999.

[10] European TSI EN 300 910. “Digital cellular telecommunications system; Radio transmission and reception”, Release 1998, pp. 8-9.

[11] J. Maligeorgos and J. R. Long, “A 2V 5.1-5.8 GHz image-reject receiver with wide dynamic range,” Proceedings of the ISSCC, San Francisco Calif., February 2000, pp. 322-323.

[12] U. L. Rhode, Microwave and Wireless Synthesizers Theory and Design, New York: Wiley & Sons Inc., 1997, pp. 467-485.

[13] S. A. Maas, Microwave Mixers, Boston, Mass.: Artech House, 1998.

[14] R. Hartley, “Single-sideband modulator,” U.S. Pat. No. 1,666,206, April 1928.

[15] D. K. Weaver, “A third method of generation and detection of single sideband signals,” Proceedings of the IRE, vol. 44, pp. 1703-1705, 1956.

[16] D. P. M. Millar, “A two-phase audio-frequency oscillator,” Journal of the IEE, vol. 74, 1934, pp.365-371.

[17] M. J. Gingell, “Single sideband modulatoin using sequence asymmetric polyphase networks,” Electronic Communications, vol. 48, 1973, p.21.

[18] J. R. Long, M. Copeland, S. Kovacic, D. Malhi and D. Harame, “RF analog and digital circuits in SiGe technology”, Proceedings of the ISSCC, San Francisco, Calif., pp. 82-83, February 1996.

[19] T-P. Liu, E. Westerwick, N. Rohani, and Y. Ran-Hong, “5 GHz CMOS radio transceiver front-end chipset,” Proceedings of the ISSCC, San Francisco, Calif., February 2000, pp. 320-321.

[20] S. H. Galal, H. F. Ragaie and M. S. Tawfik, “RC sequence asymmetric polyphase networks for RF integrated transceivers,” IEEE Transactions of Circuits and Systems—II, vol. 47, no. 1, pp 18-27, January 2000.

[21] F. Behbahani, J. Leete, T. Weeguan, Y. Kishigami, A. K. Rothmeier, K. Hoshino, A. Abidi, “An adaptive 2.4 GHz low if receiver in 0.6/spl mu/m CMOS for wideband wireless LAN,” Proceedings of the ISSCC, San Francisco, Calif., February 2000, pp. 146-147.

[22] M. Borremans, B. DeMuer, M. Steyaert, “The optimization of GHz integrated CMOS quadrature VCO's based on a poly-phase filter loaded differential oscillator,” Proceedings of the IEEE International Symposium on Circuits and Systems, Geneva Switzerland, May 2000, vol.2, pp. 729-32.

[23] M. Hirata, “Frequency multiplier circuit,” U.S. Pat. No. 5,703,509, December 1997.

[24] A. Ogawa and H. Kusakabe, “Frequency doubling circuit,” Japan. Patent 130758: Japanese Examined Patent Publication 61-025242B, Jul. 14, 1986

[25] K. Kimura, “A bipolar four-quadrant analog quarter-square multiplier consisting of unbalanced emitter-coupled pairs and expansion of its input ranges,” IEEE Journal of Solid-State Circuits, vol. SC-29, no. 1, pp. 46-55, January 1994.

[26] Y. Besson, S. Ginguene, “Frequency doubling device”, U.S. Pat. No. 5,194,820, March 1993.

[27] D. T. Cheung, J. R. Long, R. A. Hadaway, D. L. Harame, “Monolithic transformers for silicon RF IC design,” IEEE Proceedings of the BCTM, Minneapolis, Minn., September 1998, pp. 105-8.

[28] X. Zhang and Y. Yun, “Transistor based frequency multiplier,” U.S. Pat. No. 5,815,014, September 1998.

[29] G. A. M. Hurkx, “The Relevance of f_{T} and fₘₐₓ for the Speed of a Bipolar CE Amplifier Stage,” IEEE Transactions of Electron Devices, vol.44, no.5, May 1997, pp.751-81.

[30] K. C. Tsai, P. R. Gray, “A 1.9-GHz 1-W CMOS Class-E Power Amplifier for Wireless Communications,” IEEE Journal of Solid-State Circuits, vol. SC-34, no. 7, pp. 962-970, July 1999.

[31] T. L. Nguyen, “Injection-locked oscillator as frequency multiplier for millimeter-wave applications,” Proceedings of the IEEE Gallium Arsenide Integrated Circuit Symposium, Piscataway, N.J. 1999. pp. 245-248.

[32] S. Haykin, Communication Systems—Third Edition, New York: Wiley & Sons, Inc. 1994, pp. 334-335.

[33] F. Badets, Y. Deval, J. B. Begueret, A. Spataro, P. Fouillat, “A 2.7 V, 2.64 GHz fully integrated synchronous oscillator for WLAN applications,” Proceedings of the European Solid-State Circuits Conference, France 1999, pp. 210-213.

[34] A. V. Oppenheim, A. S. Willsky, I. T. Young, Signals and Systems, New Jersey: Prentice Hall, 1983.

[35] P. R. Grey and R. G. Meyer, Analysis and Design of Analog Integrated Circuits, 3rd ed., New York N.Y.: John Wiley & Sons, Inc., 1993, pp. 227-229.

[36] J. R. Long, R. Hadaway and D. Harame, “A 5.1-5.8 GHz low-power image-reject downconverter in SiGe technology,” Proceedings of the BCTM, Minneapolis Minn., September 1999, pp. 67-70.

[37] R. C. Dixon, Spread spectrum systems with commercial applications, 3rd ed., New York N.Y.: John Wiley & Sons, Inc., 1994, pp. 254-259.

[38] R. Adler, “A study of locking phenomena in oscillators”, Proceedings of the IRE, vol. 34, pp. 351-357, June 1946.

[39] K. K. Clarke, D. T. Hess, Communication Circuits: Analysis and Design, New York N.Y.: Addison-Wesley Publishing Co., 1971.

I claim:

1. An oscillator comprising at least two phase delay stages, each of said phase delay stages having an input for controlling the phase delay of the respective stage.

2. A regenerative frequency divider which includes the oscillator of claim 1.

3. An image reject mixer which includes the regenerative frequency divider of claim 2.
